(19) United States
(12) Patent Application Publication
(10) Pub. No.: US 2022/0141392 A1
(43) Pub. Date: May 5, 2022

(54) OBJECT DETECTION APPARATUS

(71) Applicant: TOYOTA JIDOSHA KABUSHIKI KAISHA, Toyota-shi (JP)

(72) Inventors: Yusuke HAYASHI, Susono-shi (JP); Taichi Kawanai, Susono-shi (JP); Sadayuki Abe, Sunto-gun (JP)

(73) Assignee: TOYOTA JIDOSHA KABUSHIKI KAISHA, Toyota-shi (JP)

(21) Appl. No.: 17/490,139

(22) Filed: Sep. 30, 2021

(30) Foreign Application Priority Data
Oct. 29, 2020 (JP) 2020-181695

(51) Int. Cl. H04N 5/243; G06K 9/00; G01S 17/86; G01S 17/931; G01S 17/89

(52) U.S. Cl. CPC H04N 5/243; G06K 9/00818; G01S 17/86; G05D 1/0248; G01S 17/931; G01S 17/89; G06K 9/00825

(57) ABSTRACT

The object detection apparatus includes: a laser light irradiation unit; a light reception element configured to detect a laser light intensity of reflection light of laser light and an ambient light intensity of reflection light of ambient light; a correlation information generation unit configured to generate correlation information indicating a correlation relationship between the laser light intensity and the ambient light intensity; an image correction unit configured to correct the camera image captured by the camera based on the correlation information and generate a corrected camera image; and an object detection unit configured to detect an object target based on the corrected camera image.

### CROSS-REFERENCE TO RELATED APPLICATION

This application claims the benefit of priority from Japanese Patent Application No. 2020-181695, filed on Oct. 29, 2020, the entire contents of which are incorporated herein by reference.

### TECHNICAL FIELD

The present disclosure relates to an object detection apparatus.

### BACKGROUND

For example, as an apparatus that detects the surrounding object target, the autonomous driving vehicle is equipped with a LIDAR that detects an object target based on the reflection light of the irradiated laser light. Further, for example, as described in the following non-patent literatures, as such a LIDAR, a LIDAR, which detects an object target by using the reflection light of the irradiated laser light and the result of detection of the reflection light of the ambient light other than the irradiated laser light, has been developed.

Non-Patent Literatures: Seigo Ito, Masayoshi Hiratsuka, Mitsuhiko Ota, Hiroyuki Matsubara, Masaru Ogawa “Localization Method based on Small Imaging LIDAR and DCNN” Information Processing Society of Japan, The 79th National Convention Lecture Proceedings

### SUMMARY

Here, in an autonomous driving vehicle, in order to detect surrounding object targets, generally, a camera that captures the surroundings is mounted in addition to the LIDAR. However, in a case of detecting an object target based on a camera image, it may not be possible to accurately detect the object target from the camera image due to the effect of ambient light, for example, the difference in light intensity between the bright portion and the shadow portion.

Therefore, the present disclosure describes an object detection apparatus capable of accurately detecting an object target based on a camera image.

According to an aspect of the present disclosure, there is provided an object detection apparatus including: a laser light irradiation unit configured to illuminate laser light; a light reception unit configured to detect a laser light intensity which is an intensity of reflection light of the laser light and an ambient light intensity, which is an intensity of reflection light of ambient light, which is light other than the laser light; a correlation information generation unit configured to generate correlation information, which indicates a correlation relationship between the laser light intensity and the ambient light intensity, based on the laser light intensity and the ambient light intensity; a camera; an image correction unit configured to correct a camera image, which is captured by the camera, based on the correlation information and generate a corrected camera image; and an object detection unit configured to detect an object target based on the corrected camera image.

Here, the laser light intensity detected by the light reception unit is not easily affected by ambient light other than the laser light. On the other hand, the ambient light intensity detected by the light reception unit is affected by the ambient light since the intensity is the ambient light intensity. Therefore, the correlation information, which indicates the correlation relationship between the laser light intensity and the ambient light intensity, can be used as an indication for indicating how much the state (existence of shadows, and the like) of the ambient light in the outside world have an effect on the camera image formed by the ambient light (visible light). Therefore, the object detection apparatus is able to generate a corrected camera image in consideration of the effect of the ambient light by correcting the camera image based on the correlation information, for example, by eliminating the effect of the ambient light. As a result, the object target can be detected accurately, based on the camera image (corrected camera image).

In the object detection apparatus, the correlation information generation unit may generate the correlation information, based on a magnitude relationship between the laser light intensity and the ambient light intensity. In such a case, the object detection apparatus can easily generate the correlation information by using the magnitude relationship between the laser light intensity and the ambient light intensity.

In the object detection apparatus, the correlation information generation unit may generate the correlation information, based on a temporal change of the laser light intensity and a temporal change of the ambient light intensity. In such a case, the object detection apparatus is able to generate the correlation information in consideration of the temporal changes of the laser light intensity and the ambient light intensity.

In the object detection apparatus, the image correction unit may correct a brightness of the camera image based on the correlation information and may generate the corrected camera image. In such a case, the object detection apparatus is able to correct the brightness of the camera image in consideration of the effect of the ambient light based on the correlation information, and is able to more accurately detect the object target based on the corrected camera image in which the brightness is corrected.

According to the aspect of the present disclosure, it is possible to accurately detect an object target based on a camera image.

### BRIEF DESCRIPTION OF THE DRAWINGS

FIG. 1 is a block diagram showing an example of an object detection apparatus according to an embodiment.

FIG. 2A is a diagram showing an example of a corrected camera image.

FIG. 2B is a diagram showing a state in which the detection area is set in the corrected camera image.

FIG. 2C is a diagram showing a state in which an object target within the detection area is detected.

FIG. 3 is a diagram showing an example of setting a detection area for detecting a blinker of a preceding vehicle based on the corrected camera image.

FIG. 4 is a flowchart showing a flow of the object target detection processing performed in the object detection ECU.

### DETAILED DESCRIPTION

Hereinafter, exemplary embodiments will be described, with reference to the drawings. In each drawing, the same or corresponding elements are represented by the same reference numerals, and repeated description will not be given.

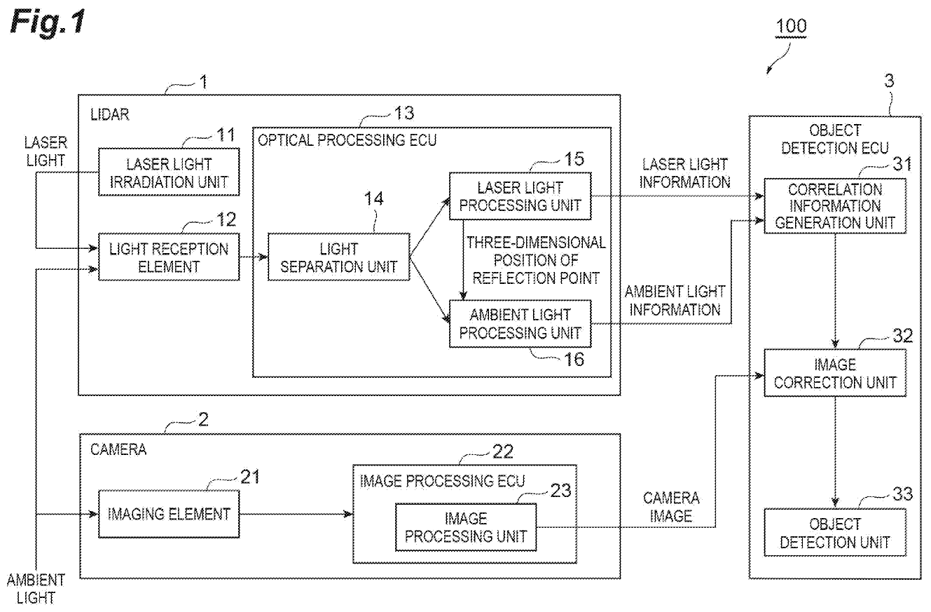

As shown in FIG. 1, the object detection apparatus 100 is mounted on a vehicle (host vehicle) and detects an object target around the host vehicle. The object target detected by the object detection apparatus 100 can be used for various controls such as autonomous driving of the host vehicle. The object detection apparatus 100 includes a light detection and ranging (LIDAR) 1, a camera 2, and an object detection electronic control unit (ECU) 3.

The LIDAR 1 irradiates the surroundings of the host vehicle with laser light, and receives the reflection light (reflection light of the laser light) reflected by the irradiated laser light on the object target. Further, the LIDAR 1 detects the intensity of the reflection light of the laser light. In addition to the reflection light of the irradiated laser light, the LIDAR 1 in the present embodiment is able to receive the reflection light (reflection light of the ambient light) reflected by the ambient light, which is the light other than the irradiated laser light, on the object target. Further, the LIDAR 1 is able to detect the intensity of the received reflection light of the ambient light. The ambient light is, for example, sunlight and light around the host vehicle such as lighting.

More specifically, the LIDAR 1 includes a laser light irradiation unit 11, a light reception element 12, and an optical processing ECU 13. The laser light irradiation unit 11 illuminates laser light toward each position in a predetermined irradiation region around the host vehicle on which the object detection apparatus 100 is mounted.

The light reception element 12 is able to receive the reflection light of the laser light illuminated from the laser light irradiation unit 11 and output a signal corresponding to the intensity of the received reflection light of the laser light. Further, the light reception element 12 is able to receive the reflection light of the ambient light other than the laser light illuminated from the laser light irradiation unit 11, and output a signal corresponding to the intensity of the received reflection light of the ambient light.

The optical processing ECU 13 is an electronic control unit which has a CPU, ROM, RAM, and the like. The optical processing ECU 13 realizes various functions by loading, for example, the programs recorded in the ROM into the RAM and executing the programs loaded in the RAM in the CPU. The optical processing ECU 13 may be composed of a plurality of electronic units.

The optical processing ECU 13 detects each of the intensity of the reflection light of the laser light received by the light reception element 12 and the intensity of the reflection light of the ambient light, based on the output signal of the light reception element 12. The optical processing ECU 13 functionally includes a light separation unit 14, a laser light processing unit 15, and an ambient light processing unit 16. In such a manner, the light reception element 12, the light separation unit 14, the laser light processing unit 15, and the ambient light processing unit 16 functions as a light reception unit that is able to detect the laser light intensity as the intensity of the reflection light of the laser light and the ambient light intensity as the intensity of the reflection light of the ambient light.

The light separation unit 14 separates the light received by the light reception element 12 into the reflection light of the laser light and the reflection light of the ambient light. For example, the light separation unit 14 is able to discriminate light having a specific flickering pattern as reflection light of laser light, and discriminate other light as reflection light of ambient light. Further, for example, the light separation unit 14 is able to discriminate the light, which is received within a predetermined time after the laser light irradiation unit 11 illuminates the laser light, as the reflection light of the laser light, and discriminate the light received at other timings as reflection light of ambient light. The predetermined time is set, in advance, based on the time from in a case where the laser light irradiation unit 11 illuminates the laser light until the irradiated laser light is reflected by the object target around the host vehicle and the reflection light of the laser light reaches the light reception element 12. As mentioned above, the reflection light of the ambient light does not include the reflection light of the laser light illuminated from the LIDAR 1. However, in a case where the ambient light includes light having the same wavelength as the laser light, the reflection light of the ambient light includes the reflection light of the light having the same wavelength as the laser light.

The laser light processing unit 15 generates laser light information, based on the result of light reception of the reflection light of the laser light received by the light reception element 12. The laser light information is generated, based on the result of light reception of a plurality of laser light beams (result of light receptions of a plurality of reflection light beams) irradiated toward each position in a predetermined irradiation region. After the laser light irradiation is completed for all the positions in the irradiation region, the LIDAR 1 again illuminates the laser light toward each position in the irradiation region. In such a manner, the LIDAR 1 performs the next irradiation processing again after the irradiation processing of irradiating all the positions in the irradiation region with the laser light is completed. The laser light information is generated each time the LIDAR 1 performs the irradiation processing.

More specifically, the laser light processing unit 15 generates laser light point information by associating the three-dimensional position of the reflection point of the irradiated laser light with the intensity of the laser light for each of the plurality of laser light beams to be irradiated toward the irradiation region. That is, the laser light point information includes the laser light intensity which is the intensity of the reflection light of the laser light. The laser light processing unit 15 generates laser light information based on the plurality of generated laser light point information. The laser light processing unit 15 is able to measure the three-dimensional position of the reflection point of the laser light, based on the irradiation angle of the laser light illuminated from the laser light irradiation unit 11 and the arrival time from the irradiation of the laser light until the reflection light of the laser light reaches the light reception element 12.

The ambient light processing unit 16 generates ambient light information, which is information about the reflection light of the ambient light, based on the result of light reception of the reflection light of the ambient light received by the light reception element 12. The ambient light information is generated every time the LIDAR 1 performs irradiation processing of illuminating a plurality of laser light beams into the irradiation region, similarly to the laser light information.

More specifically, first, the ambient light processing unit 16 acquires the three-dimensional position of the reflection point of the laser light from the laser light processing unit 15. Here, in a state where the state of each part of the LIDAR 1 such as the irradiation angle of the laser light is not changed, the position of the reflection point of the laser light received by the light reception element 12 and the position of the reflection point of the ambient light are the same as each other. Therefore, the LIDAR 1 detects the intensity of the reflection light of the ambient light in the state in a case where the reflection light of the laser light is received. Thereby, it is possible to detect the intensity of the reflection light of the ambient light reflected at the same position as the reflection point of the laser light. Therefore, the ambient light processing unit 16 generates the ambient light point information by associating the three-dimensional position of the reflection point of the laser light acquired from the laser light processing unit 15 with the intensity of the reflection light of the ambient light received by the light reception element 12. That is, the ambient light point information includes the ambient light intensity which is the intensity of the reflection light of the ambient light. The ambient light point information is generated for each of a plurality of laser light beams emitted toward the irradiation region.

The ambient light processing unit 16 generates ambient light information, based on the plurality of generated ambient light point information. That is, the ambient light processing unit 16 generates ambient light information in which the position of the reflection point of the received reflection light of the laser light (ambient light) is associated with the intensity of the received reflection light of the ambient light at each position of the reflection point.

In such a manner, the LIDAR 1 is able to generate laser light information and ambient light information, based on the result of light reception of the light reception element 12. That is, in the LIDAR 1, it is possible to generate the laser light information and the ambient light information, based on the result of light reception of one light reception element 12. Therefore, it is not necessary to perform calibration of the laser light information and the ambient light information.

The camera 2 performs imaging of an inside of a predetermined imaging region around the host vehicle and generates a camera image which is a result of the imaging. The imaging area of the camera 2 overlaps with at least a part of the irradiation area of the laser light of the LIDAR 1. The camera 2 includes an imaging element 21 and an image processing ECU 22. The imaging element 21 is able to receive the reflection light of the ambient light reflected in the imaging region and output a signal corresponding to the received reflection light of the ambient light.

The image processing ECU 22 is an electronic control unit having the same configuration as the optical processing ECU 13. The image processing ECU 22 functionally includes an image processing unit 23. The image processing unit 23 generates a camera image by a well-known method, based on the output signal of the imaging element 21.

The object detection ECU 3 detects an object target around the host vehicle, based on the detection results of the LIDAR 1 and the camera 2. The object detection ECU 3 is able to detect the object target by a well-known method, based on the result of detection of the LIDAR 1. Hereinafter, a method, in which the object detection ECU 3 detects an object target based on a camera image captured by the camera 2, will be described in detail. The object detection ECU 3 is an electronic control unit having the same configuration as the optical processing ECU 13. The object detection ECU 3 may be integrally configured with the optical processing ECU 13 or the image processing ECU 22. The object detection ECU 3 functionally includes a correlation information generation unit 31, an image correction unit 32, and an object detection unit 33.

Here, the laser light intensity included in the laser light information indicates a luminance at the reflection point of the laser light. Since the laser light intensity is based on the reflection light of the laser light illuminated from the laser light irradiation unit 11, the higher the reflectance of the object existing at the reflection point, the higher the intensity (luminance value). That is, the laser light intensity is not easily affected by the ambient light, and is constant for each object target regardless of the conditions such as the daytime, the nighttime, and the sunset.

The ambient light intensity included in the ambient light information indicates the light intensity of the background light (ambient light) at the reflection point of the ambient light (laser light). As for the ambient light intensity, for example, the intensity (light intensity) is high in a place exposed to sunlight as a background light in the daytime, and the intensity (light intensity) is low in a place shaded by a building. That is, the ambient light intensity is the ambient light intensity, and is thus affected by the ambient light. The camera image captured by the camera 2 is generated by reading the surrounding background light, and is thus similar to the ambient light information (ambient light intensity) detected by the LIDAR 1.

Therefore, the object detection ECU 3 improves a detection accuracy of the object target by correcting the camera image using the above-mentioned characteristics of the laser light intensity and the ambient light intensity. That is, the object detection ECU 3 is able to recognize the light amount of background light at each place in the camera image by using the correlation information which indicates the correlation relationship between the laser light intensity and the ambient light intensity. Therefore, the object detection ECU 3 is able to generate a corrected camera image in which the effect of the light amount of background light is suppressed by correcting the camera image, based on the correlation information. As described above, the correlation information, which indicates the correlation relationship between the laser light intensity and the ambient light intensity, can be used and obtained as an indication for indicating how much the state (existence of shadows, and the like) of the ambient light in the outside world have an effect on the camera image formed by the ambient light (visible light).

Specifically, the correlation information generation unit 31 generates correlation information, which indicates the correlation relationship between the laser light intensity and the ambient light intensity, based on the laser light intensity included in the laser light information generated by the laser light processing unit 15 and the ambient light intensity included in the ambient light information generated by the ambient light processing unit 16. This correlation information is generated for each reflection point of the laser light (ambient light).

In the present embodiment, as an example, the correlation information generation unit 31 generates correlation information, based on the magnitude relationship between the laser light intensity and the ambient light intensity. More specifically, in the present embodiment, the correlation information generation unit 31 uses a ratio of the laser light intensity and the ambient light intensity as an example of the correlation information based on the magnitude relationship between the laser light intensity and the ambient light intensity.

Here, the correlation information generation unit 31 calculates the correlation information through the expression as an example.

Correlation Information R=Ambient Light Intensity/Laser Light Intensity

However, the laser light intensity and the ambient light intensity are intensities at the same reflection point. The correlation information generation unit 31 calculates the correlation information R for each of the reflection points of the laser light (ambient light).

This correlation information R can be used for estimating the background light, and corresponds to a light amount of the background light at each coordinate of the LIDAR point cloud (reflection point of the laser light). For example, in a case where a white object target is present, the ambient light intensity is high, but the laser light intensity is also high. Therefore, the value of the correlation information R is not high. The correlation information R corresponds to the amount of background light (for example, the sun, and the like) corresponding to the place.

The image correction unit 32 corrects the camera image, based on the correlation information R generated by the correlation information generation unit 31, thereby generating a corrected camera image. In the present embodiment, as an example, the image correction unit 32 corrects the brightness of the camera image based on the correlation information R, thereby generating a corrected camera image.

Specifically, the image correction unit 32 extracts, as an example, one correlation information R from the correlation information R calculated for each reflection point of the laser light. Then, the image correction unit 32 performs gamma correction according to the extracted correlation information R on the pixels (u, v) in the camera image corresponding to the reflection points (x, y, z) of the laser light of the extracted correlation information R and the pixels around the reflection points. For example, the image correction unit 32 is able to perform gamma correction, based on the expression.

γ=γ′(normal γ value used for the entire image)+αG(R)

Here, the function G is a decreasing function of which the value decreases with R. The constant α is a parameter that determines a magnitude of the correction effect. For example, as an example, G(R)=−R+R0 may be used. R0 is a reference ratio at which the correction is zero. The image correction unit 32 performs gamma correction on each pixel in the camera image by using the correlation information R calculated for each LIDAR point cloud, thereby generating a corrected camera image.

In such a manner, the image correction unit 32 corrects the γ value at each position in the camera image, based on the plurality of correlation information R generated for each reflection point of the laser light. As a result, for example, the image correction unit 32 is able to correct the shadowed portion of the building in the camera image such that the portion is bright and to generate a corrected camera image in which the effect of the difference in appearance due to the effect of ambient light such as sunlight is suppressed.

The image correction unit 32 is able to obtain the correspondence relationship (positional correspondence relationship) between the reflection point of the laser light and the pixel of the camera image in accordance with a well-known method such as performing calibration in advance or matching the feature points.

The object detection unit 33 detects the object target, based on the corrected camera image generated by the image correction unit 32. In such a manner, the object detection unit 33 is able to suppress the dependence on the ambient light and accurately detect the object target by using the corrected camera image in which the effect of the ambient light is suppressed. The object detection unit 33 is able to detect an object target using a well-known image recognition processing or the like, based on the corrected camera image.

Here, in a case where the object detection unit 33 detects the object target based on the corrected camera image, the object detection unit 33 may detect the object target by limiting the detection area of the object target in the corrected camera image based on the correlation information and performing image recognition processing and the like on the limited detection area. Hereinafter, as an example of a specific method in such a case, a method of recognizing a sign and recognizing a blinker of a vehicle will be described.

Based on the correlation information generated by the correlation information generation unit 31, the object detection unit 33 extracts a reflection point at which there is a high possibility that a sign is present at the reflection point for each of the reflection points of the laser light. The signs described herein are road signs installed on the side of the road, license plates attached to vehicles, and the like. Reflective materials, which diffusely reflect light in a case where the materials are illuminated by a light or the like, are used for the signs to improve visibility. Therefore, in the sign, the laser light intensity tends to be higher than the ambient light intensity. Based on this feature, the object detection unit 33 is able to determine whether or not there is a high possibility that a sign is present for each of the reflection points of the laser light, based on the correlation information which is the ratio of the laser light intensity to the ambient light intensity.

Next, the object detection unit 33 detects a plane from the point cloud data of the reflection points of the laser light, which is likely to have a sign. Here, since the sign is generally planar, it can be considered that the sign is present in a planar portion of the extracted point cloud data. That is, here, the object detection unit 33 is able to recognize the area in which the sign is present by detecting the plane from the extracted point cloud data. The object detection unit 33 is able to detect a plane by using, for example, a well-known method such as singular value decomposition. Further, the object detection unit 33 may recognize the area in which the sign is present, based on the shape of the plane (for example, a quadrangle, a rhombus, a circle, and the like) in addition to the plane.

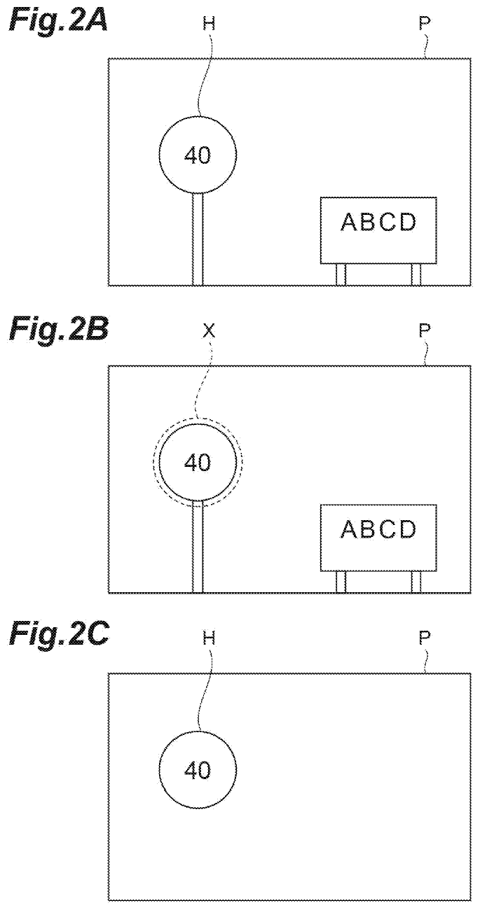

The object detection unit 33 sets a detection area for detecting the sign on the corrected camera image generated by the image correction unit 32, based on the area in which the recognized sign is present. For example, there is a corrected camera image P shown in FIG. 2A. As shown in FIG. 2B, the object detection unit 33 sets a detection area X for detecting the sign, based on the area in which the recognized sign is present for the corrected camera image P. Here, the detection area X is set in the portion of the road sign H in the corrected camera image P.

The object detection unit 33 detects the sign by performing image recognition processing or the like on the set detection area X in the corrected camera image P. Thereby, the object detection unit 33 is able to detect the display content of the road sign H as shown in FIG. 2C.

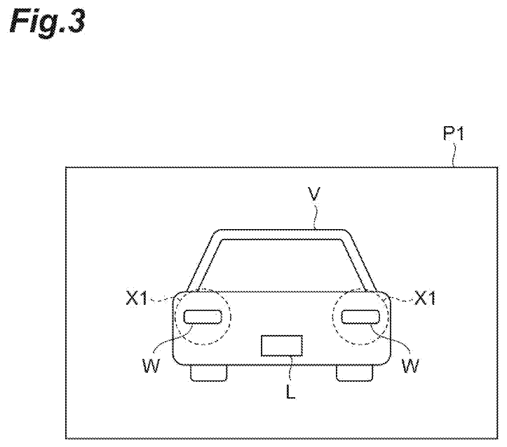

In addition, the object detection unit 33 is able to detect the blinker of the vehicle, based on the area in which the recognized sign is present. For example, as shown in FIG. 3, the preceding vehicle V is shown in the corrected camera image P1. The object detection unit 33 recognizes the portion of the license plate L of the preceding vehicle V as the area in which the sign is present. In such a case, the object detection unit 33 sets the detection area X1 at a position where the left and right blinkers W are assumed to be present, based on the area where the sign is present (the position of the license plate L). Then, the object detection unit 33 detects the blinker W by performing image recognition processing or the like on the set detection area X1 in the corrected camera image P1. Thereby, the object detection unit 33 is able to detect whether or not the blinker W of the preceding vehicle V is lit.

In such a manner, the object detection unit 33 is able to accurately detect the detection target by suppressing the erroneous detection of characters and light other than the detection target such as the sign and the blinker. Further, in the object detection unit 33, it is possible to improve the speed of the object target detection processing by limiting the detection area.

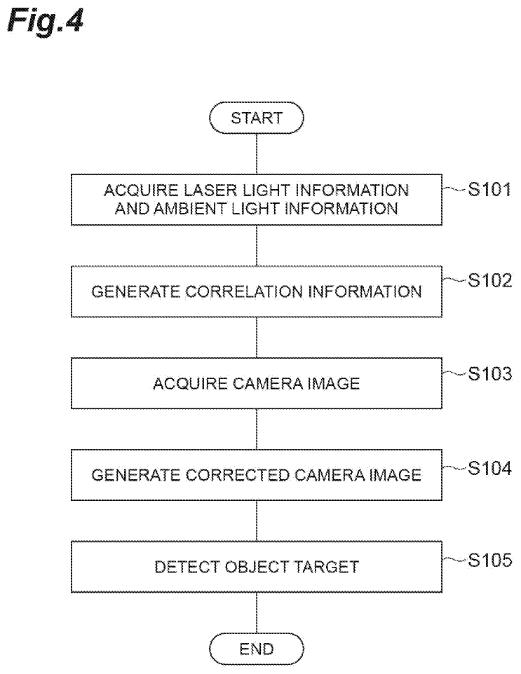

Next, the flow of the object target detection processing performed by the object detection ECU 3 of the object detection apparatus 100 will be described with reference to the flowchart of FIG. 4. The detection processing shown in FIG. 4 is repeatedly executed at predetermined time intervals after the start of the object target detection processing. Further, in the processing of S101 to S103, the order of processing of S103 is not limited to the order shown in FIG. 2.

As shown in FIG. 4, the correlation information generation unit 31 acquires the laser light information and the ambient light information from the LIDAR 1 (S101). The correlation information generation unit 31 generates correlation information, based on the laser light intensity included in the laser light information and the ambient light intensity included in the ambient light information (S102). The image correction unit 32 acquires the camera image from the camera 2 (S103).

The image correction unit 32 corrects the camera image, based on the correlation information generated by the correlation information generation unit 31, thereby generating a corrected camera image (S104). The object detection unit 33 detects the object target, based on the corrected camera image generated by the image correction unit 32 (S105).

As described above, the object detection apparatus 100 is able to generate a corrected camera image in consideration of the effect of ambient light by correcting the camera image based on the correlation information, for example, by excluding the effect of ambient light. As a result, it is possible to accurately detect an object target, based on the corrected camera image (corrected camera image).

The correlation information generation unit 31 generates correlation information, based on the magnitude relationship between the laser light intensity and the ambient light intensity. In such a case, the object detection apparatus 100 can easily generate correlation information by using the magnitude relationship between the laser light intensity and the ambient light intensity. In the present embodiment, the correlation information generation unit 31 uses a ratio of the laser light intensity and the ambient light intensity as an example of the correlation information based on the magnitude relationship between the laser light intensity and the ambient light intensity. In such a case, the correlation information generation unit 31 is able to easily generate correlation information, based on the ratio of the laser light intensity to the ambient light intensity.

By correcting the brightness of the camera image based on the correlation information, the image correction unit 32 is able to correct the brightness of the camera image in consideration of the effect of the ambient light. Then, the object detection unit 33 is able to detect the object target more accurately, based on the corrected camera image of which the brightness is corrected.

Although the embodiments of the present disclosure have been hitherto described above, the present disclosure is not limited to the above embodiment. The present disclosure may be modified in various ways without departing from the spirit of the present disclosure.

For example, the correlation information generation unit 31 is not limited to generating correlation information, based on the magnitude relationship between the laser light intensity and the ambient light intensity. For example, the correlation information generation unit 31 may generate correlation information, based on the temporal change of the laser light intensity and the temporal change of the ambient light intensity. In such a case, the correlation information generation unit 31 is able to generate correlation information in consideration of the temporal changes of the laser light intensity and the ambient light intensity. As described above, the correlation information generation unit 31 is able to generate the correlation information by various methods as long as the information indicates the correlation relationship between the laser light intensity and the ambient light intensity.

What is claimed is:

1. An object detection apparatus comprising:
a laser light irradiation unit configured to illuminate laser light;
a light reception unit configured to detect a laser light intensity which is an intensity of reflection light of the laser light and an ambient light intensity, which is an intensity of reflection light of ambient light, which is light other than the laser light;
a correlation information generation unit configured to generate correlation information, which indicates a correlation relationship between the laser light intensity and the ambient light intensity, based on the laser light intensity and the ambient light intensity;
a camera;
an image correction unit configured to correct a camera image, which is captured by the camera, based on the correlation information and generate a corrected camera image; and
an object detection unit configured to detect an object target based on the corrected camera image.

2. The object detection apparatus according to claim 1, wherein the correlation information generation unit generates the correlation information, based on a magnitude relationship between the laser light intensity and the ambient light intensity.

3. The object detection apparatus according to claim 1, wherein the correlation information generation unit generates the correlation information, based on a temporal change of the laser light intensity and a temporal change of the ambient light intensity.

4. The object detection apparatus according to claim 1, wherein the image correction unit corrects a brightness of the camera image based on the correlation information and generates the corrected camera image.
